(19) United States
(12) Patent Application Publication
(10) Pub. No.: US 2009/0160666 A1
(43) Pub. Date: Jun. 25, 2009

(54) SYSTEM AND METHOD FOR OPERATING AND POWERING AN ELECTRONIC DEVICE

(75) Inventors: Hemant Jha, Chicago, IL (US); Michael Baumberger, Chicago, IL (US); Lana Berkovich, Chicago, IL (US); Munish Sikka, Naperville, IL (US)

Correspondence Address: FITCH EVEN TABIN AND FLANNERY, 120 SOUTH LASALLE STREET, SUITE 1600, CHICAGO, IL, 60603-3406, US

(73) Assignee: THINK/THING, Chicago, IL (US)

(21) Appl. No.: 11/962,741

(22) Filed: Dec. 21, 2007

(51) Int. Cl. H02J 7/00; G08B 21/00

(52) U.S. Cl. 340/665; 320/128

(57) ABSTRACT

At least one movement being applied to an electronic device is sensed and the movement is associated with an interaction with the electronic device. The device is operated at least in part according to the movement and at least some of the at least one movement is converted into energy. The energy is stored in a rechargeable energy storage system and the electronic device is operated using the energy stored in the rechargeable energy storage system.

### FIELD OF THE INVENTION

The field of the invention relates to the operation of electronic devices and, more specifically, to using forces or movements of the device to at least in part operate and/or power these devices.

### BACKGROUND OF THE INVENTION

Various types of users with different backgrounds and abilities utilize today's electronic devices. For example, children are using electronic devices at an increasingly early age. Adults use electronic devices for personal and business purposes. Older adults and the disabled also desire to use electronic devices. Due to the differences in the background and abilities of users, the level of user sophistication in operating these devices varies widely.

Because of the wide range of user sophistication, various attempts have been made to simplify user interfaces (e.g., keyboards) and some previous systems have used motion sensing components in this regard. When motion sensing was used, existing interface components (e.g., keyboards) were replaced with motion sensing components to implement device commands. For example, some previous devices sensed particular device movements in order to allow a user to scroll through the text of a document or select an item on a liquid crystal display (LCD). These previous motion sensing devices have been limited to implementing conventional device commands and no attempt has been made to increase the command set or vocabulary for the device.

Furthermore, previous motion sensing devices required a one-to-one correspondence between movements of the device and device commands. More specifically, a gesture had to be carefully performed in order to be recognized by the system. To give one example, some devices had to be tilted at a specific angle in order for a particular command to be recognized. Any variation in the expected movement typically resulted in the device being unable to recognize the motion and perform the command.

As a result of the above-mentioned problems, prior devices were typically not intuitive to operate and required complicated instruction sets to allow users to successfully utilize the device. To take one example, users were frequently required to study and/or memorize complicated and extensive manuals in order to determine how to move the device in order to perform various commands.

Another problem associated with previous devices has been their inability to maintain user attention over long periods of time. While some devices (e.g., toys) have attempted to provide components or functionality that keep the attention of the user (e.g., by using brightly colored and oversized buttons), these approaches have proved to be only short term solutions. For instance, many children quickly become bored with predictable, non-interactive feedback, regardless of the aesthetics of the packaging.

Portable electronic devices also typically used power sources such as batteries and these batteries eventually run short of power. This can be a problem because accessing some of these batteries to make a replacement may be difficult and batteries may not always be readily available. If rechargeable batteries are used, an outlet is required and the user is required to wait until the recharging process is complete before they can again use their electronic device. In addition, batteries are not easily disposed of and have a tremendous impact on the environment.

Other previous devices allowed the age or skill level of the device to be manually adjusted over time. Unfortunately, these approaches typically required the manual activation of buttons or switches, which could be cumbersome or burdensome in many situations. Additionally, these approaches were often inflexible to use since the same skill levels had to be used and often in the same scripted order.

### SUMMARY OF THE INVENTION

Electronic devices described herein can be utilized by users possessing a wide range of device sophistication and operating knowledge. These approaches allow a user to power or charge a device through the primary interface mechanism of the device. For instance, in the case of a device operated by a movement or movements, the very operation of the device keeps the device powered or charged. Consequently, the approaches described herein do not require that users constantly replace their batteries. In so doing, operation and enjoyment of the electronic devices is substantially enhanced.

In many of these embodiments, at least one movement applied to an electronic device is sensed and the movement is associated with an interaction with the electronic device. The device is operated at least in part according to the movement. At least some of the energy associated with the movement is converted into energy and the energy is stored in a rechargeable energy storage system. The electronic device is then operated using the energy stored in the rechargeable energy storage system. The energy stored and used can be electrical, mechanical, electromagnetic, chemical, kinetic, thermal or other types of energy as well as combinations of any of these types.

In some of these approaches, operating the device according to the movement and the converting the movement to energy occur substantially parallel in time. In others of these approaches, converting the movement to energy and operating the device according to the movement occur serially or substantially simultaneously.

Various types of mechanisms can convert the movement into energy. In one approach, an electrical power generation mechanism such as an electromagnetic induction device may be used. Other examples of generator mechanisms are possible.

Feedback may be provided to the user as a result of the movement. For example, haptic feedback, visual feedback, and audio feedback may be provided at the device. Remote feedback may be provided to locations outside the device.

In others of these embodiments, at least one force applied to the electronic device by a human user is sensed. A force category for the force is determined and a feedback action is provided to a human user at an output interface. The feedback action is associated with the force category. At least some of the force is converted into energy and the energy is stored in a rechargeable energy storage system. The electronic device is operated using the energy stored in the rechargeable energy storage system. Operating the device and converting the force may occur substantially simultaneously, in parallel, or serially.

Thus, approaches are provided allowing electronic devices to be used and recharged through their normal use and operation. Thus, the batteries or other rechargeable energy storage elements of these devices are extremely long lasting and in many examples never need to be replaced. So configured, the devices described herein enhance the experience of the user with the device and increase satisfaction of the user with the device.

### BRIEF DESCRIPTION OF THE DRAWINGS

FIG. 1 is a block diagram of an electronic device according to various embodiments the present invention;

FIG. 2 comprises a flowchart of an approach for operating an electronic device utilizing sensed force measurements according to various embodiments of the present invention;

FIG. 3 comprises a flowchart of an approach for operating an electronic device using sensed force measurements and other inputs according to various embodiments of the present invention;

FIG. 4 comprises a flowchart of an example of an approach for measuring and categorizing forces applied to an electronic device according to various embodiments of the present invention;

FIG. 5 comprises a perspective view of one example of an electronic device that uses applied force to provide feedback to a user according to various embodiments of the present invention;

FIGS. 6a-c comprise diagrams illustrating various approaches for measuring and utilizing force using the sensor layout of the device shown in FIG. 5 according to various embodiments of the present invention;

FIG. 7 comprises a flowchart of an approach for operating an electronic device based upon force patterns according to various embodiments of the present invention;

FIG. 8 comprises a flowchart of an approach for operating an electronic device based upon force patterns according to various embodiments of the present invention;

FIG. 9 comprises a block diagram of a electronic device according to various embodiments of the present invention;

FIG. 10 comprises a flowchart of the operation of an electronic device according to various embodiments of the present invention; and

FIG. 11 comprises a perspective view of an electronic device according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION OF THE PREFERRED EMBODIMENTS

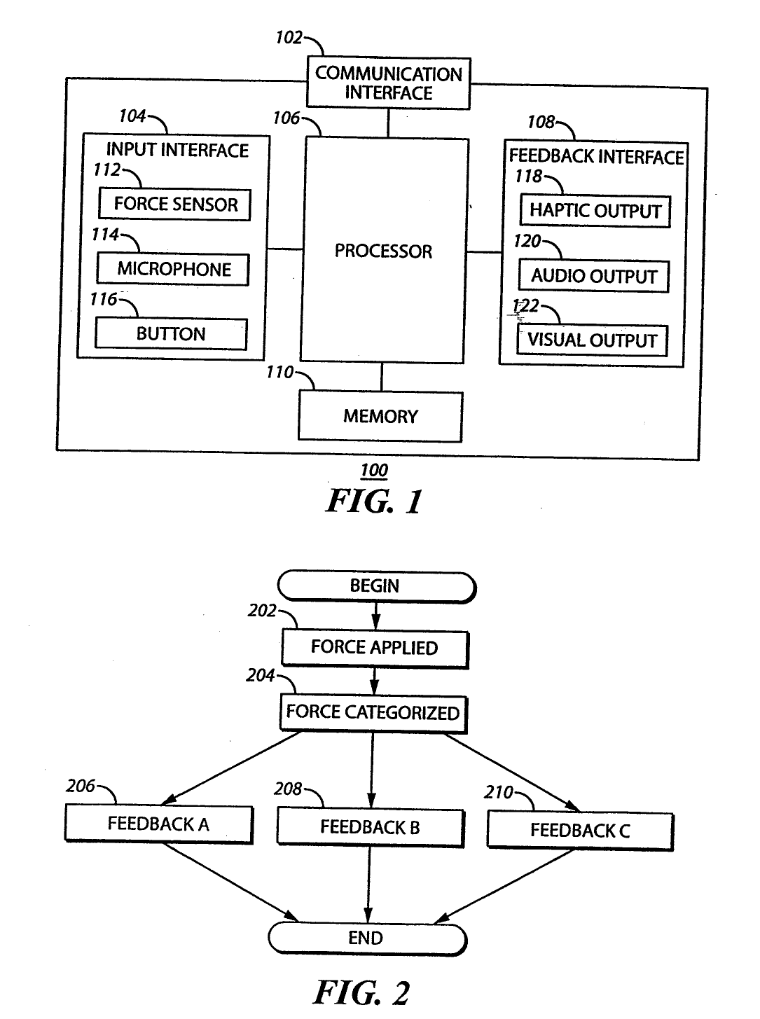

Referring now to FIG. 1, an electronic device 100 comprises a communication interface 102, an input interface 104, a processor 106, a feedback interface 108, and a memory 110. The input interface includes a force sensor 112, a microphone 114, and a mode selection button 116. The feedback interface 108 includes a haptic feedback output component 118, an audio output component 120, and a visual output component 122. A battery or other power storage device (not shown in FIG. 1) may be charged via the movement or forces applied to the electronic device 100

It will be appreciated that the input interface 104 may include other types of components. It will also be understood that the number of components of any particular type may also vary. For example, any number of force sensors can be used. Similarly, it will be understood that additional components may be used as part of the feedback interface 108 and that the number of these components may also vary. For example, more than one visual output component (e.g., both a display and a light band) may be used. In another example, feedback components other than or in addition to visual, audio, or haptic feedback may be used.

The force sensor 112 is any type of sensor that measures an applied force. The force sensor 112 or combinations of force sensors may measure any type of force characteristic such as the magnitude, direction, or some other characteristic of an applied force.

In one example, multiple force sensors are positioned at different locations of the device 100. Specifically, six sensors (e.g., top, bottom, right, left, front, and back sensors) may be disposed within the device to measure applied force. Based upon the magnitude of the force and the identity of the sensor (or sensors) that detect the force, an overall magnitude and direction of the force may be determined.

The microphone 114 receives audible energy (e.g., sounds, noises, human speech) from outside the device 100. The mode selection button 116 determines a mode of operation. The mode can be any type of mode, such as an active mode or inactivate (e.g., sleep) mode. Additionally, the mode may relate to the skill level of users such as age-based skill levels or education-based levels. As mentioned, other types of input components may also be provided.

The haptic feedback output component 118 provides haptic motion or other sensory feedback at the device 100. For example, a motor may be provided that moves, shakes, vibrates, rumbles, or otherwise provides a haptic response to a user at the device 100. For example, when the device 100 is awakened by picking it up or when operating the device, a coordinated audio/haptic response may occur. This could be a short burst of rumbling and a “ding” from the speaker or a series of vibrations and sound effects.

The audio output component 120 broadcasts audible response to the user. For example, one or more speakers may be provided. Music, human speech, tones, alarms, or any other type of audible response may be broadcast by the audio output component 120.

The visual output component 122 provides one or more visual outputs to the user. For example, a display may be provided. In another example, a light band (e.g., a series of light emitting diodes (LEDs) arranged to form a band) may be provided. The light band may be operated so as to flash, pulse, change color, or provide any other possible visual experience to the user. In one particular example, light band surrounding the device 100 may pulse faintly when the user sleeping and the pulsing stops when the device is picked up/awakened. In another example, as the device 100 is activated, the light band becomes a solid color or changes brightness level.

The communication interface 102 is used to download data from an external source (e.g., a computer network, the Internet, a digital camera, a satellite, a phone line, and/or a cellular phone) and store the data in the memory 110. In this regard, the communication interface 102 provides conversion capabilities (e.g., from radio frequency (RF) signals to digital signals) so that the signals and/or data received from the external source may be in the proper format so as to be able to be utilized by the device 100.

The memory 110 may be any type of memory device. In one example, the memory 110 is a flash memory. However, it will be appreciated that other types of memory (e.g., random access memory (RAM), read only memory (ROM)) or other combinations of memory elements can also be used. The processor 106 is any type of analog or digital component such as a microprocessor that can process instructions.

The device 100 can be used in any type of application such as a toy, a computer game, or a learning aid. In one particular example, the device 100 can be a voice recognition soother. In this case, if a child wakes up and starts talking or screaming into the device, the device 100 responds by turning on/waking up and displaying an image, displaying soothing colors, or broadcasting soothing sounds to the child.

If a light band is used, the light band may change in some way as a response to the child's voice (e.g., flashing in some sequence or tracking around the perimeter of the device 100 or speeding up/slowing down or changing color). The sound broadcast to the child may be a lullaby or the voice of a parent.

In another example, the device 100 may be used as a rehabilitation tool. The device may be issued by medical staff to patients undergoing rehabilitation after injury or surgery. In the privacy of their own home, the patient can perform exercises that are monitored by the device 100 for the proper technique and force threshold, thereby providing feedback if exercises are too rigorous or not rigorous enough. As the patient continues his/her rehabilitation program, the device 100 provides feedback to encourage greater range of movement and increased force.

In still another example, the device 100 is used to aid in developing technique in a particular sport. For instance, the device can be used to document an athlete's throwing pattern or the pattern of a golf swing and provide feedback to correct potentially dangerous motions or poor form.

In yet another example, the device 100 functions as a developmental tool for individuals with learning disabilities or the mentally challenged and promotes communication and interaction through sensory reinforcement.

In still another example, the device 100 may be used as a compositional instrument, documenting a person's everyday (or choreographed) movements and representing them through corresponding feedback. For example, walking with the device 100 to work or dancing with the device 100 could generate entirely unique digital compositions and could be recorded and shared via WiFi and the Internet, or any other suitable technology or communication mechanism.

In other examples, the device 100 may provide other functions to users such as cellular phone, person digital assistant, or personal computer functions. The device 100 can also be connected via the communication interface 102 to any computer network or communication system allowing the user to interact with these systems.

In still other examples, the device 100 may learn the patterns of operation of a user and operate accordingly. For example, a child's movement of the device may define how the device is operated. In this case, the device 100 learns the forces applied by the child and applies a function to these applied forces. The function determines a pattern of operation corresponding to the child's age and/or motor-skill development level. As the child's motor skills develop, and he/she is capable of more control and a greater variety of the types of forces applied to the device 100, the device 100 detects the corresponding pattern and provides more and/or different functionality (e.g., image manipulation and viewing, games, or puzzles) to the child.

Referring now to FIG. 2, one example of operating an electronic device utilizing sensed force measurements is described. At step 202, a force is applied to an electronic device. The force may be applied to one or more surfaces of the device. At step 204, the force is categorized. With this step, one or more characteristics of the force (e.g., magnitude or direction) are determined and used to determine a force category (e.g., a force category associated with rough gestures or a force category associated with smooth gestures).

Based upon the determined force category, one of three different feedback actions are determined at step 206 (feedback A), step 208 (feedback B), or step 210 (feedback C). In one approach, each feedback is different. For instance, step 206 may provide a visual feedback, step 208 may broadcast an audible feedback, and step 210 may provide a haptic feedback. In other examples, the same overall type of feedback may be provided, but the characteristics of the feedback may vary. For example, step 206 may broadcast audible feedback that is a first sound or noise, step 208 may broadcast audible feedback that is a second sound or noise, and step 210 may broadcast audible feedback that is a third sound or noise. In still another example, each of the steps may provide a different combination of feedback. For example, each of the steps may provide a different combinations of visual, audible, and haptic feedback.

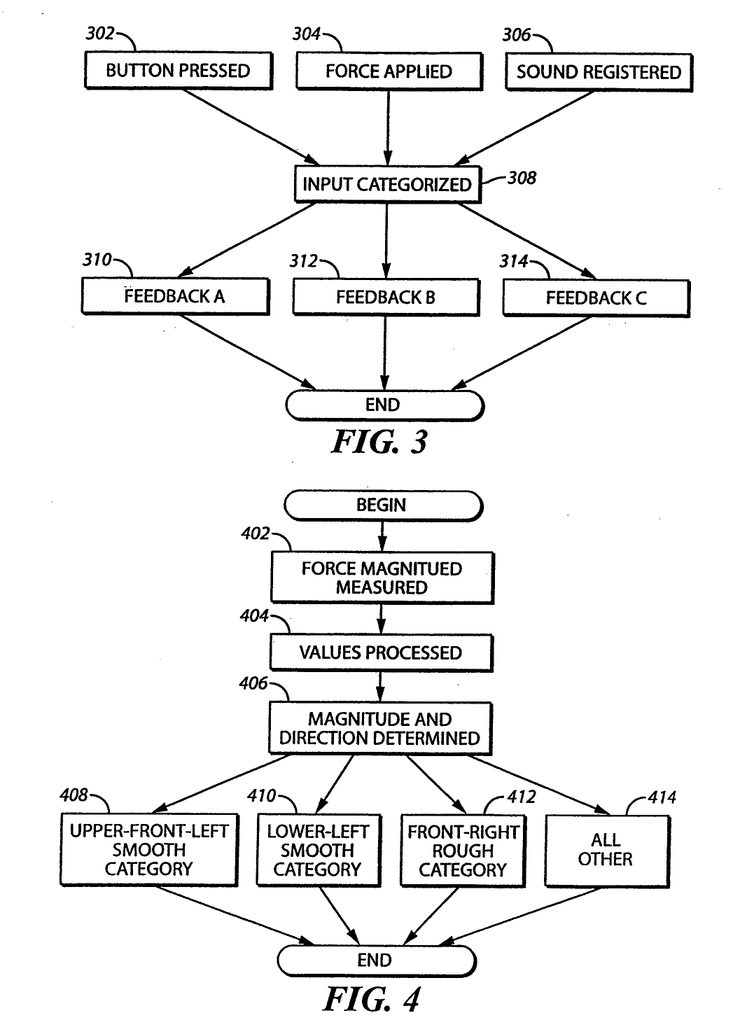

Referring now to FIG. 3, an example of operating an electronic device utilizing sensed force measurements and other inputs is described. At step 302, a button (e.g., a mode selection button) is actuated indicating a certain type of information (e.g., an operating mode) is to be processed by the device. At step 304, a force is applied to an electronic device. The force may move the device or the device may remain stationary. The force may be applied to one or more surfaces of the device. At step 306, a sound is received and registered by the device, for example, via a microphone. It will be appreciated that the inputs shown in the example of FIG. 3 are an example of one possible combination of inputs. Other types of inputs and other combinations of inputs may also be used.

At step 308, the inputs received by the device are categorized. With this step, one or characteristics of the inputs (e.g., force magnitude or force direction, operating mode, characteristics of the detected sound) are determined and used to determine a force category (e.g., a category associated with rough gestures of newborn children or a category associated with smooth gestures made by toddlers).

Based upon the determined force category, one of three different feedback actions are determined at step 310 (feedback A), step 312 (feedback B), or step 314 (feedback C). As with the example of FIG. 2, in one approach, each feedback is different. For instance, step 310 may provide a visual feedback, step 312 may broadcast an audible feedback, and step 314 may provide a haptic feedback. In other examples, the same overall type of feedback is provided, but the characteristics of the feedback may vary. For example, step 310 may broadcast audible feedback that is a first sound or noise, step 312 may broadcast audible feedback that is a second sound or noise, and step 314 may broadcast audible feedback that is a third sound or noise. In still another example, each of the steps may provide a different combination of feedback. For example, each of the steps may provide a different combination of visual, audible, and haptic feedback.

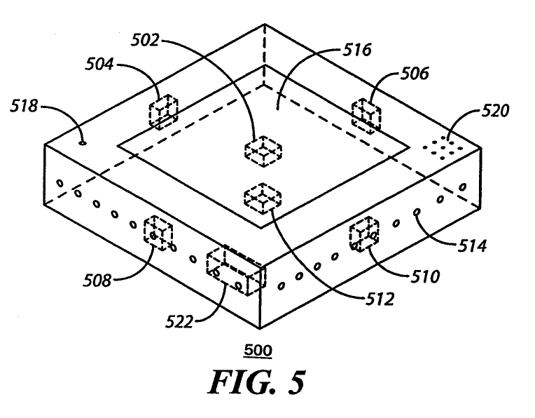

Referring now to FIG. 4, one example of an approach for measuring and categorizing forces applied to an electronic device is described. At step 402, the magnitude of the force applied to an electronic device is measured at various sensors positioned about the device. As described herein with respect to the device of FIG. 5, front, back, top, bottom, right, and left sensors may be used to detect the magnitude of the force at various points of the device.

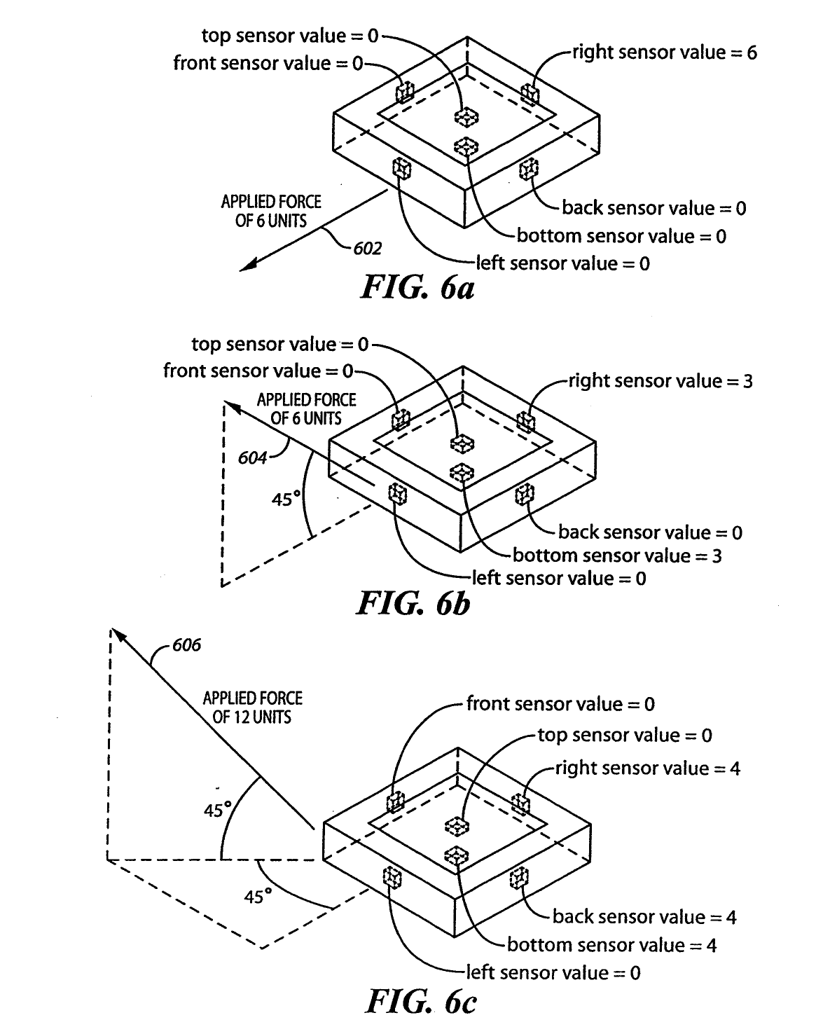

At step 404, the sensor values are processed, for example, the raw sensed values are converted into a digital format for use by the device. At step 406, the overall magnitude and overall direction of the received force is determined. More specifically, as described with respect to the example of FIG. 6 described herein, the overall magnitude and direction of the received force is determined based upon the identity of the sensors detecting the force and the amount of force detected by each sensor. For instance, if only the bottom sensor detects a force of magnitude M, then it may be determined that a force of magnitude M has been applied to the device in an upward direction.

Based upon the magnitude and direction of the force, one of several force categories 408, 410, or 412 are selected and associated with the force. For instance, forces of a first determined magnitude and direction range may be associated with the category 408, which, in this example, is a category relating to smooth forces that have been applied to the upper, front, and left portion of the device. Forces of a second magnitude and direction range may be categorized as smooth forces applied to the lower left portions of the device. Still other forces may be associated with the force category 412, which are rough forces applied to the front and right portions of the device. All other forces having all other magnitudes and directions are categorized as belonging to category 414. Based upon the determined force categories, different types of feedback actions may be taken.

It will be appreciated that the force categories indicated in FIG. 4 are only one example of many possible types of categories. Other types of force categories based upon other types of characteristics besides smooth and rough force gestures may also be determined and used.

Referring now to FIG. 5, one example of an electronic device 500 that uses measured force to provide feedback is described. In this example, the electronic device is a handheld device that comfortably fits within the hands of a human user. However, it will be understood that devices having any set of dimensions may also be used.

The device 500 includes a top sensor 502, a front sensor 504, a right sensor 506, a left sensor 508, a back sensor 510, and a bottom sensor 512. Additionally, the device includes a light band 514, a display 516, a microphone 518, a speaker 520, and a vibration motor 522. All of these components are integral with the device.

The top sensor 502, front sensor 504, right sensor 506, left sensor 508, back sensor 510, and bottom sensor 512 measure a force magnitude. As will be described herein in greater detail with respect to FIGS. 6a -c, the magnitude and identities of the particular sensors that detect an applied force are used to determine the overall magnitude and overall direction of the applied force.

The light band 514 includes a series of light emitting diodes (LEDs) arranged in a band around the periphery of the device. The light band 514 may be used to provide different types of visual feedback to the user. For example, the LEDs may be of different colors or have different brightness levels, and may be operated to show these different colors or brightness levels based upon the force category. In another example, the light band 514 may be pulsed or activated/deactivated based upon other circumstances.

The display 516 may be any type of screen or display that provides any type of visual images to a user. In one example, the display 516 may be a liquid crystal display (LCD). Other types of displays can also be used.

The microphone 518 is any type of audio component used to receive audible energy (e.g., sounds, noises, or human speech) from outside the device. The speaker 520 is any type of component used to broadcast sounds to the user of the device. The vibration motor 522 is any type of haptic component used to move, wobble, pulsate, rumble, or otherwise present any type of haptic sensation to a user.

It will be appreciated that the device of FIG. 5 is one type of device with one type of configuration. Other devices having different components, different numbers of particular components (e.g., sensors), different component layouts, and/or different dimensions may also be used.

Referring now to FIGS. 6a -c, examples of determining force magnitudes and directions using the device of FIG. 5 are described. In the examples of FIGS. 6a -c, force magnitudes are measured according to arbitrary force units. However, it will be appreciated that this force magnitude may be any force unit such as pounds or newtons.

In the example of FIG. 6a, the top sensor measures a force of 0 units, the bottom sensor measures 0 units, the right sensor measures 6 units, the left sensor measures 0 units, the front sensor measures 0 units, and the back sensor measures 0 units. From these readings and the identities of the sensors associated with these readings, it can be determined that applied force of 6 units has been detected in the direction indicated by an arrow labeled with reference numeral 602.

In the example of FIG. 6b, the top sensor measures a force value of 0 units, the bottom sensor measures 3 units, the right sensor measures 3 units, the left sensor measures 0 units, the front sensor measures a force of 0 units, and the back sensor measures 0 units. From these readings and the identities of the sensors associated with these readings, it can be determined that applied force of 6 units has been detected in the direction indicated by an arrow labeled with reference numeral 604.

In the example of FIG. 6c, the top sensor measures a force value of 0 units, the bottom sensor measures 4 units, the right sensor measures 4 units, the left sensor measures 0 units, the front sensor measures 0 units, and the back sensor measures 4 units. From these readings and the identities of the sensors associated with these readings, it can be determined that applied force of 12 units has been detected in the direction indicated by an arrow labeled with reference numeral 606.

It will be understood that the examples shown in FIGS. 6a -c are examples only and other approaches can be used to determine the magnitude and direction of force being applied to the electronic device. It will also be understood that the numbers and placement of sensors on the device may also vary according to the dimensions, needs, and requirements of the device and/or device users.

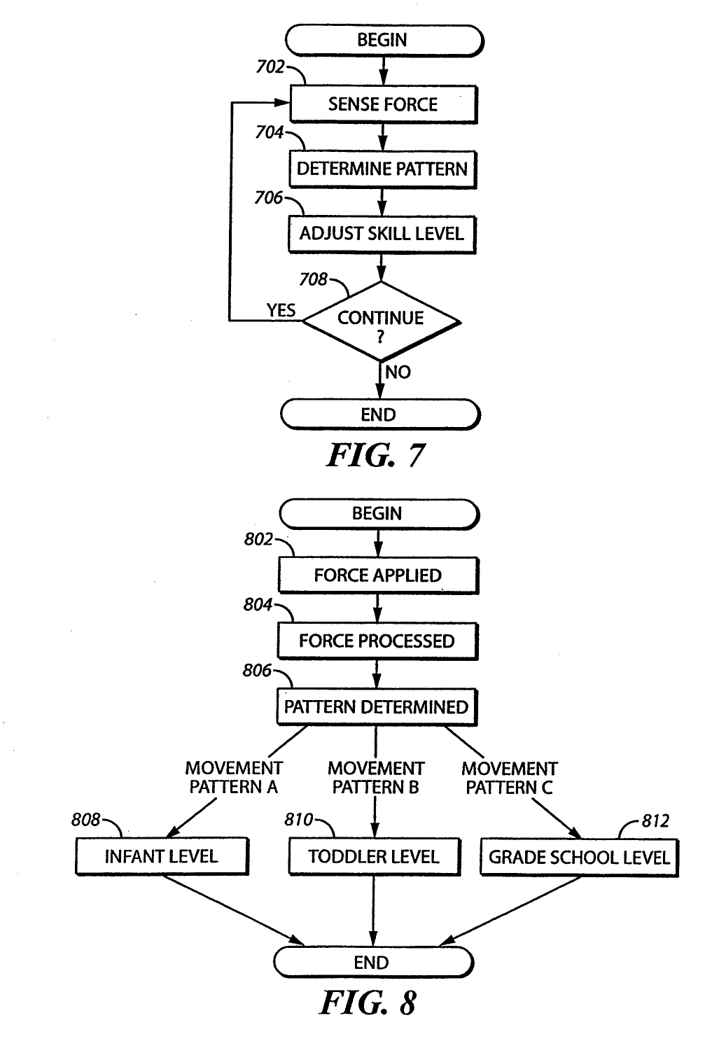

Referring now to FIG. 7, one example of operating a device according to determined force patterns is described. At step 702, a force is sensed. The force may include a magnitude and direction and as mentioned elsewhere in this specification, this force can be measured by one or more force sensors at the device. At step 704, the force measured at step 702 is used along with previous force measurements (measured over a period of time and which may be stored in a memory) to determine a force pattern. For example, a force pattern associated with a particular age group (e.g., newborn, toddler, grade school child) may be determined.

At step 706, the skill level of the device is automatically adjusted according to the determined force pattern. For example, the operation of the device may be adjusted to a difficulty level associated with a particular age. In addition, different images may be displayed to the user and/or, if a light band is used, the light band may be operated in a predetermined way. Appropriate audio and/or haptic feedback may also be provided to the user.

At step 708, it is determined if it is desired to continue receiving and processing additional force patterns. If the answer is negative, execution ends. If the answer is affirmative, execution continues with step 702 as described above.

Referring now to FIG. 8, an example of adjusting the operational characteristics of the device according to a sensed force pattern is described. At step 802, different forces are applied to the device over a period of time. At step 804, the applied forces are measured, and their characteristics (e.g., direction, magnitude, duration) determined and stored.

At step 806, a force pattern for the measured forces is determined. This force pattern may relate to the characteristics (e.g., magnitudes, directions, and/or durations) of one or more application of forces measured over some period of time. Based upon the characteristics of the applied forces, one of three different movement patterns (movement pattern A, movement pattern B, or movement pattern C) is determined. Each of the patterns (movement pattern A, movement pattern B, or movement pattern C) may be described according to certain characteristics (e.g., magnitudes, directions, and/or durations) of applied forces.

In this example, if movement pattern A is determined, then the pattern is associated with an infant pattern of activity at step 808. If movement pattern B is determined, then the pattern is associated with toddler pattern of activity at step 810. If movement pattern C is determined, then the pattern is associated with grade school child pattern of activity at step 812. Based upon the determined pattern, operating characteristics of the device may be automatically adjusted accordingly. For example, different types of games, puzzles, or visual content may be provided to the child based upon the determined pattern.

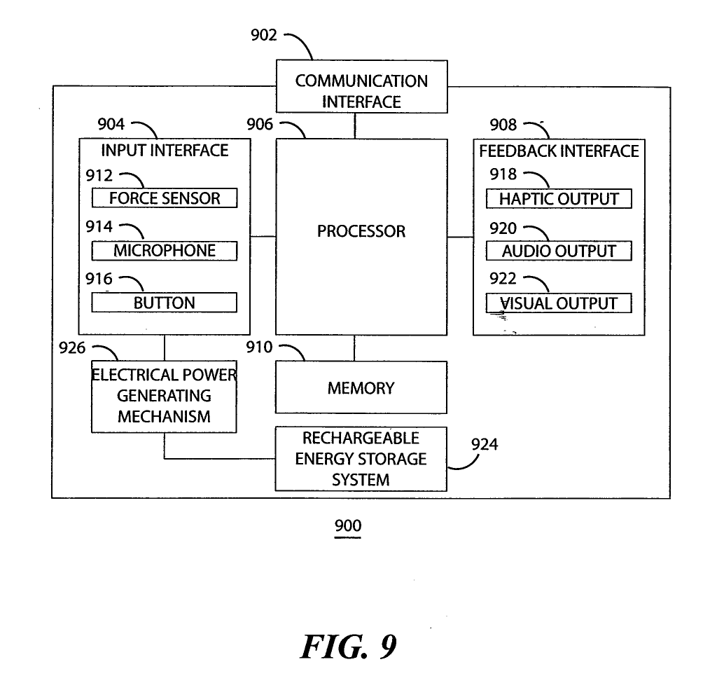

Referring now to FIG. 9, one example of an electronic device 900 that generates power through the same movements used to operate the device 900 is described. The electronic device 900 comprises a communication interface 902, an input interface 904, a processor 906, a feedback interface 908, a memory 910, an electrical power generating mechanism 926, and a rechargeable energy storage system 924. The input interface 904 includes a force sensor 912, a microphone 914, and a mode selection button 916. The feedback interface 908 includes a haptic feedback output component 918, an audio output component 920, and a visual output component 922. Remote feedback may be provided to elements outside the device 900 via the communication interface 902.

It will be appreciated that the input interface 904 may include other types of components. It will also be understood that the number of components of any particular type may also vary. For example, any number of force sensors can be used. Similarly, it will be understood that additional components may be used as part of the feedback interface 908 and that the number of these components may also vary. For example, more than one visual output component (e.g., both a display and a light band) may be used. In another example, feedback components other than or in addition to visual, audio, or haptic feedback may be used.

The force sensor 912 is any type of sensor that measures an applied force or movement. The force sensor 912 or combinations of force sensors may measure any type of force or movement characteristic such as the magnitude, direction, or some other characteristic of an applied force.

In one example, multiple force sensors are positioned at different locations of the device 900. Specifically, six sensors (e.g., top, bottom, right, left, front, and back sensors) may be disposed within the device to measure applied force. Based upon the magnitude of the force and the identity of the sensor (or sensors) that detect the force, an overall magnitude and direction of the force may be determined.

The microphone 914 receives audible energy (e.g., sounds, noises, human speech) from outside the device 900. The mode selection button 916 determines a mode of operation. The mode can be any type of mode, such as an active mode or inactivate (e.g., sleep) mode. Additionally, the mode may relate to the skill level of users such as age-based skill levels or education-based levels. As mentioned, other types of input components may also be provided.

The haptic feedback output component 918 provides haptic motion or other sensory feedback at the device 900. For example, a motor may be provided that moves, shakes, vibrates, rumbles, or otherwise provides a haptic response to a user at the device 900. For example, when the device 900 is awakened by picking it up or when operating the device, a coordinated audio/haptic response may occur. This could be a short burst of rumbling and a “ding” from the speaker or a series of vibrations and sound effects.

The audio output component 920 broadcasts audible response to the user. For example, one or more speakers may be provided. Music, human speech, tones, alarms, or any other type of audible response may be broadcast by the audio output component 920.

The visual output component 922 provides one or more visual outputs to the user. For example, a display may be provided. In another example, a light band (e.g., a series of light emitting diodes (LEDs) arranged to form a band) may be provided. The light band may be operated so as to flash, pulse, change color, or provide any other possible visual experience to the user. In one particular example, light band surrounding the device 900 may pulse faintly when the user sleeping and the pulsing stops when the device is picked up/awakened. In another example, as the device 900 is activated, the light band becomes a solid color or changes brightness level.

The communication interface 902 is used to download data from an external source (e.g., a computer network, the Internet, a digital camera, a satellite, a phone line, and/or a cellular phone) and store the data in the memory 910. In this regard, the communication interface 902 provides conversion capabilities (e.g., from radio frequency (RF) signals to digital signals) so that the signals and/or data received from the external source may be in the proper format so as to be able to be utilized by the device 900.

The memory 910 may be any type of memory device. In one example, the memory 910 is a flash memory. However, it will be appreciated that other types of memory (e.g., random access memory (RAM), read only memory (ROM)) or other combinations of memory elements can also be used. The processor 906 is any type of analog or digital component such as a microprocessor that can process instructions.

The rechargeable energy storage system 924 is any type of energy storage device that stores electrical energy (e.g., a battery, capacitor, super capacitor, or coil spring). In other examples, other types of energy (e.g., mechanical, electromagnetic, chemical, kinetic, or thermal to name a few examples) may be stored in the rechargeable energy storage system 924. The electrical power generating mechanism 926 is any type of device that converts the movement or applied force to the device into electrical energy. In this respect, it can utilize any combination of electrical and/or mechanical components. The electrical power generating mechanism 926 accounts for any range of movement of the device 900. In one example, the electrical power generating mechanism 926 includes a component for each possible axis of movement (e.g., the x-axis, y-axis, and z axis). Each of these separate components may be an electromagnetic induction device that includes a coil of conductive wire that is wrapped around a tube and the tube include a magnet which, when moved past the coil, generates electrical power in the conductive wire (by the law of electromagnetic induction). The wire is coupled to the rechargeable energy storage system 924 where the electrical energy is stored. It will be appreciated that the electromagnetic induction device is only one type of power generation element that can be used and other types of power generation elements are possible.

It will be appreciated that the energy generated by the movement/operation of the device 900 may be solely responsible for recharging the rechargeable energy storage system 924. In other examples, the energy so generated may be supplemented by conventional means such as using a power jack connected to an electrical outlet, which helps to recharge the rechargeable energy storage system 924.

In some examples, the electrical power generating mechanism 926 receives forces and generates energy by itself. In other examples, the electrical power generating mechanism 926 is incorporated with the sensor 912.

In one example, the electronic device 900 is a learning device used by children for learning the alphabet by playing a game (e.g., shaking the device). Each “shake” causes a new letter to be displayed and this movement causes the device 900 to automatically recharge. In this example, the force required to display the next letter is also used to generate electrical energy that is eventually used to power the device 900. Consequently, the operation of the device inherently produces energy to operate the device.

The device 900 can be used in any type of application such as a toy, a computer game, or a learning aid. In one particular example, the device 900 can be a voice recognition soother. In this case, if a child wakes up and starts talking or screaming into the device, the device 900 responds by turning on/waking up and displaying an image, displaying soothing colors, or broadcasting soothing sounds to the child. The child may pick up the device and play with it during this time. As before, operation of the device causes the rechargeable energy storage system 924 in the device 900 to be recharged or prolong its life. “Prolonging its life” as used herein denotes that energy is provided directly to the components of the device 900 without be stored, entering, or recharging the rechargeable energy storage device 924. “Prolonging its life” may also denote that energy is provided to the components, having passed through the rechargeable energy storage system while not charging it.

If a light band is used, the light band may change in some way as a response to the child's voice (e.g., flashing in some sequence or tracking around the perimeter of the device 900 or speeding up/slowing down or changing color). The sound broadcast to the child may be a lullaby or the voice of a parent.

In another example, the device 900 may be used as a rehabilitation tool. The device may be issued by medical staff to patients undergoing rehabilitation after injury or surgery. In the privacy of their own home, the patient can perform exercises that are monitored by the device 900 for the proper technique and force threshold, thereby providing feedback if exercises are too rigorous or not rigorous enough. As the patient continues his/her rehabilitation program, the device 900 provides feedback to encourage greater range of movement and increased force. Again, the operation of the device causes the rechargeable energy storage system 924 in the device 900 to be recharged or prolong its life.

In still another example, the device 900 is used to aid in developing technique in a particular sport. For instance, the device can be used to document an athlete's throwing pattern or the pattern of a golf swing and provide feedback to correct potentially dangerous motions or poor form. As before, the operation and use of the device causes rechargeable energy storage system 924 in the device 900 to be recharged or prolong its life.

In yet another example, the device 900 functions as a developmental tool for individuals with learning disabilities or the mentally challenged and promotes communication and interaction through sensory reinforcement. As with many of the other examples, the operation and use of the device causes the rechargeable energy storage system 924 in the device 900 to be recharged or prolong its life.

In still another example, the device 900 may be used as a compositional instrument, documenting a person's everyday (or choreographed) movements and representing them through corresponding feedback. For example, walking with the device 900 to work or dancing with the device 900 could generate entirely unique digital compositions and could be recorded and shared via WiFi and the Internet, or any other suitable technology or communication mechanism. As with many of the other examples described herein, normal operation of the device causes the rechargeable energy storage system 924 in the device 900 to be recharged or prolong its life.

In other examples, the device 900 may provide other functions to users such as cellular phone, person digital assistant, or personal computer functions. The device 900 can also be connected via the communication interface 902 to any computer network or communication system allowing the user to interact with these systems.

In still other examples, the device 900 may learn the patterns of operation of a user and operate accordingly. For example, a child's movement of the device may define how the device is operated. In this case, the device 900 learns the forces applied by the child and applies a function to these applied forces. The function determines a pattern of operation corresponding to the child's age and/or motor-skill development level. As the child's motor skills develop, and he/she is capable of more control and a greater variety of the types of forces applied to the device 900, the device 900 detects the corresponding pattern and provides more and/or different functionality (e.g., image manipulation and viewing, games, or puzzles) to the child.

In another example of operating the device 900, at least one movement being applied the electronic device 900 is sensed and the movement is associated with an interaction with the electronic device 900. The device 900 is operated at least in part according to the movement. At least some of the at least one movement is converted into electrical energy and the electrical energy is stored in the rechargeable energy storage system 924. The electronic device is operated using the electrical energy stored in the rechargeable energy storage system 924.

In some of these approaches, operating the device 900 according to the movement and the converting the movement to electrical energy occur substantially parallel in time. In others of these approaches, converting the movement to electrical energy and operating the device 900 according to the movement occur serially or substantially simultaneously.

Various types of mechanisms can convert the movement into electrical energy. In one approach, an electrical power generation mechanism 926 such as a electromagnetic induction device may be used. Other examples of generator mechanisms are possible.

Feedback may be provided to the user as a result of the movement. For example, haptic feedback, visual feedback, and audio feedback may be provided at the output interface 908 of the device 900. Remote feedback may be provided from locations outside the device (e.g., to the Internet via the communication interface 902).

In another example of the operation of the device 900, at least one force applied to the electronic device 900 by a human user is sensed by the sensors 912. A force category for the at least one force is determined and a feedback action is provided to a human user at the output interface 908. The feedback action is associated with the force category. At least some of the at least one force is converted into electrical energy and the electrical energy is stored in the rechargeable energy storage system 924. The electronic device 900 is operated using the electrical energy stored in the rechargeable energy storage system 924.

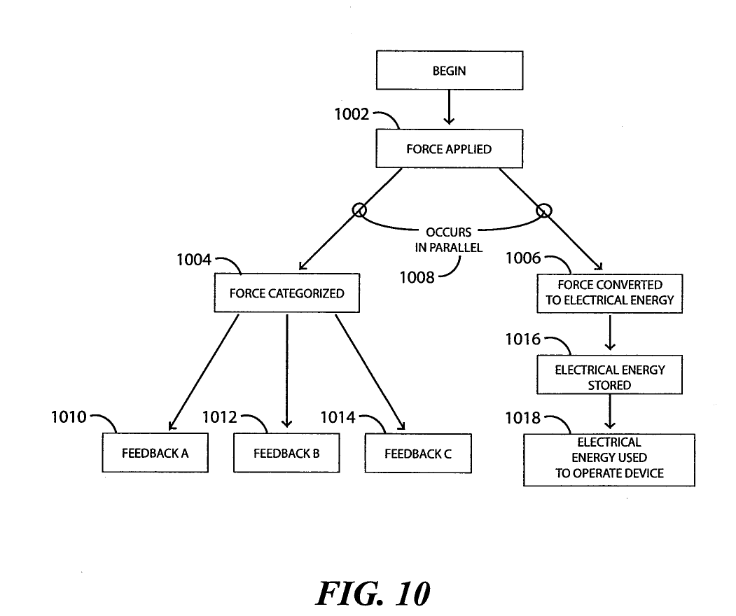

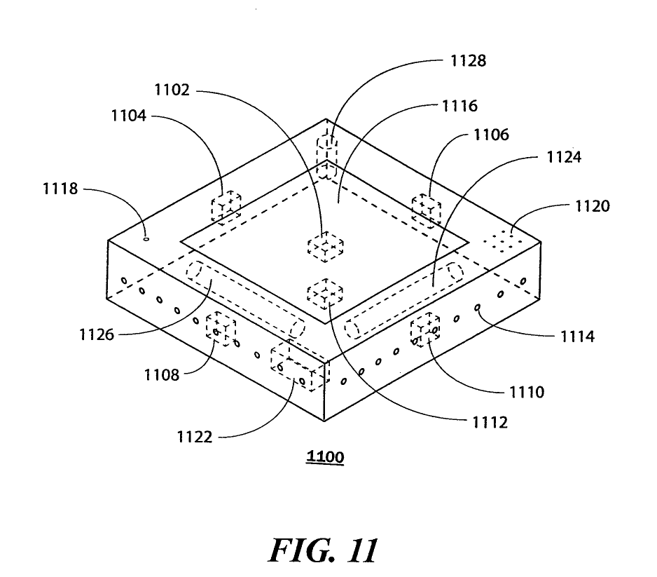

Referring now to FIG. 10, one example of operating an electronic device utilizing sensed force measurements is described. At step 1002, a force is applied to an electronic device. The force may be applied to one or more surfaces of the device.

At step 1004, the force is categorized. With this step, one or more characteristics of the force (e.g., magnitude or direction) are determined and used to determine a force category (e.g., a force category associated with rough gestures or a force category associated with smooth gestures).

Based upon the determined force category, one of three different feedback actions are determined at step 1006 (feedback A), step 1008 (feedback B), or step 1010 (feedback C). In one approach, each feedback is different. For instance, step 1006 may provide a visual feedback, step 1008 may broadcast an audible feedback, and step 1010 may provide a haptic feedback. In other examples, the same overall type of feedback may be provided, but the characteristics of the feedback may vary. For example, step 1006 may broadcast audible feedback that is a first sound or noise, step 1008 may broadcast audible feedback that is a second sound or noise, and step 1010 may broadcast audible feedback that is a third sound or noise. In still another example, each of the steps may provide a different combination of feedback. For example, each of the steps may provide a different combinations of visual, audible, and haptic feedback.

At step 1006, the force applied to the device is converted to electrical energy, for example, using a power generating device such as an electromagnetic induction device. At step 1016, electrical energy is stored in a rechargeable energy storage system (e.g., a battery, capacitor, or super capacitors). At step 1018, the electrical energy in the rechargeable energy storage system is used to operate the device. It will be appreciated that the energy generated by the movement/operation of the device may be solely responsible for recharging the rechargeable energy storage system. In other examples, the energy so generated may be supplemented by conventional means such as using a power jack connected to an electrical outlet, which helps to recharge the rechargeable energy storage system.

Some or all of the steps 1004, 1010, 1012, and 1014 may occur in parallel (i.e., at the same time or during the same time period) as any one or any combination of the steps 1006, 1016, or 1018. Alternatively, some or all of the steps 1004, 1010, 1012, and 1014 may occur serially or substantially simultaneously with respect to steps 1006, 1016, or 1018. In one example, step 1006 may be performed after all of the steps 1004, 1010, 1012, and 1014 are performed. In another example, steps 1006, 1016, and 1018 may be performed before all of the steps 1004, 1010, 1012, and 1014 are performed.

Referring now to FIG. 11, one example of an electronic device 1100 that uses measured force to provide feedback is described. In this example, the electronic device 1100 is a handheld device that comfortably fits within the hands of a human user. However, it will be understood that devices having any set of dimensions may also be used.

The device 1100 includes a top sensor 1102, a front sensor 1104, a right sensor 1106, a left sensor 1108, a back sensor 1110, and a bottom sensor 1112. Additionally, the device includes a light band 1114, a display 1116, a microphone 1118, a speaker 1120, and a vibration motor 1122. Further, the device includes an x-axis power generator 1124, a y-axis power generator 1126, a z-axis power generator 1128, and a rechargeable energy storage system (not shown), All of these components are integral with the device.

The top sensor 1102, front sensor 1104, right sensor 1106, left sensor 1108, back sensor 1110, and bottom sensor 1112 measure a force magnitude. The magnitude and identities of the particular sensors that detect an applied force are used to determine the overall magnitude and overall direction of the applied force.

The light band 1114 includes a series of light emitting diodes (LEDs) arranged in a band around the periphery of the device. The light band 1114 may be used to provide different types of visual feedback to the user. For example, the LEDs may be of different colors or have different brightness levels, and may be operated to show these different colors or brightness levels based upon the force category. In another example, the light band 1114 may be pulsed or activated/deactivated based upon other circumstances.

The display 1116 may be any type of screen or display that provides any type of visual images to a user. In one example, the display 1116 may be a liquid crystal display (LCD). Other types of displays can also be used.

The microphone 1118 is any type of audio component used to receive audible energy (e.g., sounds, noises, or human speech) from outside the device. The speaker 1120 is any type of component used to broadcast sounds to the user of the device. The vibration motor 1122 is any type of haptic component used to move, wobble, pulsate, rumble, or otherwise present any type of haptic sensation to a user. Remote feedback to elements outside the device 1100 may also be provided by the device.

As the device 1100 is operated, the x-axis power generator 1124, y-axis power generator 1126, and z-axis power generator 1128 receive the forces applied to the device 1100 and convert these forces into electrical energy for use by the device 1100. The device 1100 can be used in any of the applications described herein and still other applications are possible. As with all of these examples, the operation and use of the device as normally used causes the rechargeable energy storage system in the device to be recharged or prolong its life.

It will be appreciated that the device of FIG. 11 is one type of device with one type of configuration. Other devices having different components, different numbers of particular components (e.g., sensors, power generators), different component layouts, and/or different dimensions may also be used.

Thus, approaches are provided allowing electronic devices to be used and recharged through their normal use and operation. Thus, the batteries of these devices are extremely long lasting and in many examples never need to be replaced. So configured, the devices described herein enhance the experience of the user with the device and increase satisfaction of the user with the device.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for operating an electronic device comprising:
at an electronic device:
sensing at least one force applied to the electronic device by a human user;
determining a force category for the at least one force and providing a feedback action to a human user at an output interface, the feedback action associated with the force category;
converting at least some of the at least one force into energy;
storing the energy in an rechargeable energy storage system; and
operating the electronic device using the energy stored in the rechargeable energy storage system.

2. The method of claim 1 wherein the energy comprises energy selected from a group consisting of electrical energy, mechanical energy, electromagnetic energy, chemical energy, kinetic energy, and thermal energy.

3. The method of claim 1 wherein determining a force category and converting the at least one force to energy occur substantially simultaneously.

4. The method of claim 1 wherein determining a force category and converting the at least one force to energy occur substantially in parallel.

5. The method of claim 1 wherein determining a force category and converting the at least one force to energy occur serially.

6. The method of claim 1 wherein converting the at least one force utilizes a power generating mechanism.

7. A method for operating an electronic device comprising:
at an electronic device:
sensing at least one movement being applied to the electronic device, the movement being associated with an interaction with the electronic device;
operating the device at least in part according to the movement;
converting at least some of the at least one movement into energy;
storing the energy in an rechargeable energy storage system; and
operating the electronic device using the energy stored in the rechargeable energy storage system.

8. The method of claim 7 wherein the energy comprises energy selected from a group consisting of electrical energy, mechanical energy, electromagnetic energy, chemical energy, kinetic energy, and thermal energy.

9. The method of claim 7 wherein operating the device and converting the at least one force to energy occur substantially simultaneously.

10. The method of claim 7 wherein operating the device and converting the at least one force to energy occur substantially in parallel.

11. The method of claim 7 wherein operating the device and converting the at least one movement to energy occur serially.

12. The method of claim 7 wherein converting the at least one movement utilizes a power generation mechanism.

13. The method of claim 7 further comprising providing feedback to the user and wherein providing feedback comprises providing at least one feedback action selected from a group comprising: providing haptic feedback; providing visual feedback; providing audio feedback; and providing remote feedback.

14. An electronic device comprising:
a force sensor configured and arranged to sense at least one force applied to the device by a human user;
an output interface;
a controller coupled to the output interface, the controller being configured and arranged to determine a force category for the at least one force and to provide a feedback action to a human user at the output interface, the feedback action associated with the determined force category;
an rechargeable energy storage system; and
an energy generator, the energy generator coupled to the rechargeable energy storage system, the energy generator configured and arranged to convert at least some of the at least one force to energy and store the energy in the rechargeable energy storage system.

15. The electronic device of claim 14 wherein the energy comprises energy selected from a group consisting of electrical energy, mechanical energy, electromagnetic energy, chemical energy, kinetic energy, and thermal energy.

16. The electronic device of claim 14 wherein the rechargeable energy storage system comprises a battery.

17. The electronic device of claim 14 wherein the energy generator comprises an electrical power generating mechanism.

18. The electronic device of claim 14 wherein the force category is determined and the at least one force is converted substantially simultaneously.

19. The electronic device of claim 14 wherein the force category is determined and the at least one force is converted substantially in parallel.

20. The electronic device of claim 14 wherein the force category is determined and the at least one force is converted serially.
